(19) United States
(12) Patent Application Publication
(10) Pub. No.: US 2004/0034538 A1
(43) Pub. Date: Feb. 19, 2004

(54) Process for the commercialization of waste product disposal

(76) Inventors: Mark S. Fenelon, Nashville, TN (US); Paul J. Fenelon, Nashville, TN (US)

Correspondence Address: HARNESS, DICKEY & PIERCE, P.L.C., P.O. BOX 828, BLOOMFIELD HILLS, MI, 48303, US

(21) Appl. No.: 10/218,107

(22) Filed: Aug. 13, 2002

(51) Int. Cl. B65F 5/00

(52) U.S. Cl. 705/1; 705/14; 705/414; 705/500; 414/787

(57) ABSTRACT

A process for the commercialization of waste product disposal is provided including providing a waste receptacle at a commercial establishment. Consumers are allowed to pay to dispose of their waste products in the waste receptacle. According to one aspect of the invention, a credit voucher or coupon is issued to the consumer for a portion of the amount charged for use of the waste receptacle. The system of the present invention affords a commercial establishment with the ability to substantially increase consumer traffic at their location.

### FIELD OF THE INVENTION

The present invention relates to a process for the disposal of waste products, and more particularly, to a process for the commercialization of waste product disposal.

### BACKGROUND AND SUMMARY OF THE INVENTION

While the home improvement and repair industry is a very vibrant marketplace, there has been little attention given to streamlining the waste disposal process. Currently, “do-it-yourselfers” and small professional contractors have few alternatives for disposing of the solid waste generated by their projects. Few municipalities have effective plans for the public disposal of construction and demolition waste. The only alternative for the disposal of this waste is for the individual to contract with a private waste disposal entity or to self haul the waste to a municipally owned, inconvenient, transfer station or dump site.

Arranging for private waste disposal can significantly increase the marginal cost of a given home improvement/repair project. Additionally, the vast majority of municipal solid waste disposal locations are not within a convenient proximity to the population density, and are often not open in the evenings and on weekends when individual demand is the greatest. In addition, the disposal of hazardous waste is also inconvenient since municipalities often offer only limited time periods each year for proper disposal of hazardous waste materials, such as motor oil, batteries, and other hazardous chemicals. The lack of convenience for these types of waste disposal reduces the likelihood that individuals will properly dispose of their hazardous waste.

Traditionally, businesses have relied upon marketing techniques such as sales, rebates, give-aways, etc., in order to attract customers to their locations.

The method of the present invention affords a commercial entity an opportunity to substantially increase consumer traffic at its location by placing a convenience/transfer station at a specific commercial location within a defined geographic market which can be utilized by anyone from a “do-it-yourself” homeowner to a professional contractor to dispose of their waste materials in a cost effective and environmentally sound manner. The method of the present invention offers a more cost effective disposal method by using “pay-as-you-throw” pricing and provides a site at a commercially accessible location frequented by the “do-it-yourselfer” and professional contractor that allows the individuals to discard the waste materials at a place and time which best meet their needs.

According to another aspect of the invention, the commercial establishment can issue credit vouchers to users that can be redeemed at the host establishment for a portion of the cost of the waste disposal. Accordingly, the method of the present invention provides a waste management system that addresses a non-satisfied need within the home, construction, improvement, and maintenance markets. This distinctive method of waste management offers a select aggregate market a means by which to conveniently streamline its waste disposal while simultaneously reducing the cost of transportation, associated transaction times, as well as product procurement and/or replacement within participating commercial entities.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic diagram illustrating the principles of the process for commercialization of waste product disposal according to the principles of the present invention; and

FIG. 2 illustrates a schematic view of an alternative waste receptacle having a lid which is activated or removed in order to allow access to a user.

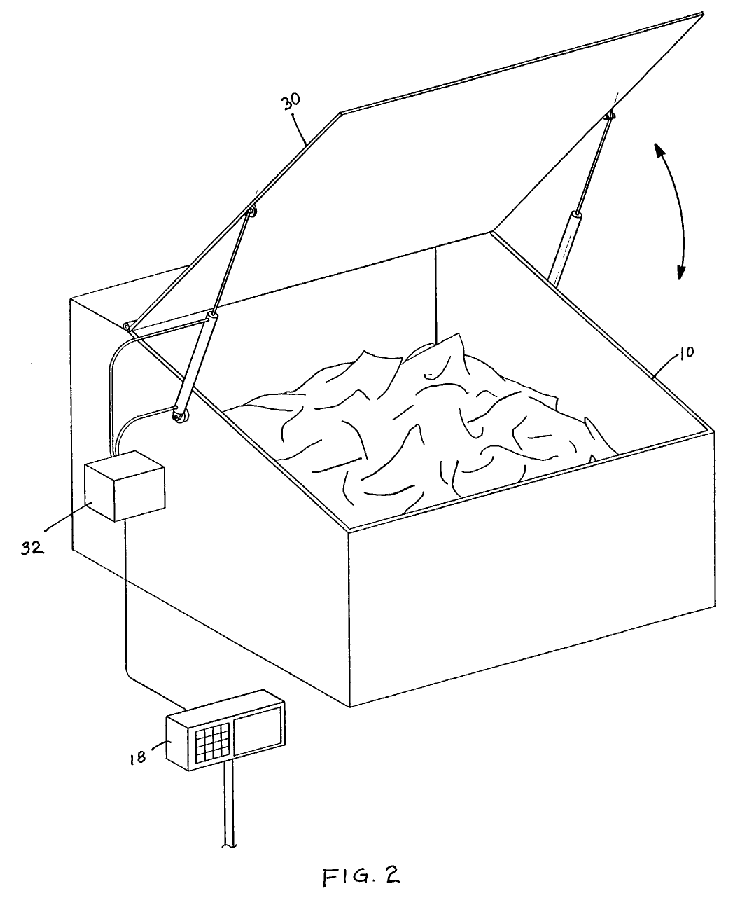

### DETAILED DESCRIPTION OF THE PREFERRED EMBODIMENTS

The following description of the preferred embodiment(s) is merely exemplary in nature and is in no way intended to limit the invention, its application, or uses.

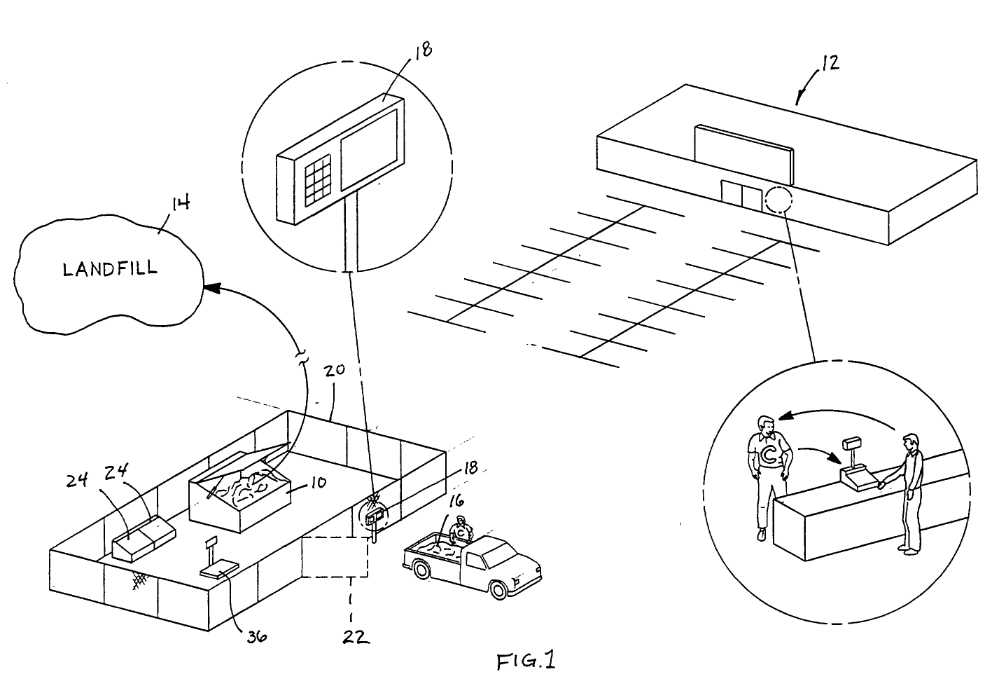

With reference to FIG. 1, a process for the commercialization of waste product disposal will now be described. According to the principles of the present invention, a waste receptacle 10 is provided at a commercial location 12 which is accessible to the general public and remote from any landfill location 14. Specifically, the waste receptacle 10 can be placed in the parking lot or an enclosed portion of the commercial establishment 12. The commercial establishment 12 can be of the type such as a home products store, commercial products store, super center, discount retailer, lumberyard, hardware store, agricultural store, warehouse club, or grocery store and yet may not be limited specifically thereto. According to the principles of the present invention, a consumer can utilize an automated transactional system or can receive permission from a cashier or attendant to utilize the waste receptacle 10 to dispose of his/her waste materials 16. The cashier or attendant could be located in the commercial establishment 12 or at the location of the waste receptacle 10.

According to one aspect of the present invention, the cashier/attendant or other automated transaction center 18 can provide an access code to the user in exchange for consideration to allow the Consumer access to the waste receptacle 10. The access code can be entered into a computerized controller 18, which upon entry of the appropriate code allows the Consumer access to the waste receptacle 10. According to one example, the waste receptacle 10 is surrounded by a wall-type structure 20, such as a fence or other enclosed area provided with a gate or access door 22 which can be opened upon entry of the proper code through the controller 18. The system disclosed allows for a fully automated system of waste product disposal, but can also be implemented using an attendant or cashier who permits access to the waste receptacle 10.

Additional hazardous waste receptacles 24 can also be provided for receipt of different types of hazardous waste materials or chemicals that require specialized processing. Each of the hazardous waste receptacles 24 is specifically labeled to identify the types of hazardous waste materials that can be deposited in each of the receptacles 24.

As an alternative to the fenced in or wall type surrounding 20, the waste receptacle 10 can be provided with a removable lid 30 that can be opened automatically by a hydraulic or other actuator system or by hand upon entry of the appropriate access code through the computerized access system 18.

According to further aspects of the present invention, a user can insert a credit card or debit card into a slot provided on the computerized access system 18 for carrying out the transaction. According to one aspect of the present invention, the user can be charged based upon a single unloading fee or alternatively charged by weight. The computerized access system 18 can be electronically attached to a scale 36 that is disposed in the vicinity of the waste receptacle 10 so that the waste material 16 can be weighed prior to the disposal in the waste receptacle 10. The weight of the waste material can then be utilized by the computerized access system to determine the amount to be charged to the Consumer. Alternatively, a scale can be implemented as part of the waste receptacle 10 itself such that the scale system can monitor the amount of additional weight added to the waste receptacle by the consumer so that the consumer can be charged accordingly. Again, as noted above, these transactions can be performed through an automated system or using an attendant for receiving and/or weighing the waste materials and determining the amount to be charged to the consumer.

As can be readily understood by one having ordinary skill in the art, the level of automation that can be utilized with the method of the present invention can be varied depending upon the specific needs and services provided by the commercial establishment 12. The computerized access system 18 can request information from the Consumer such as the types of waste material being discarded. The computerized access system 18 can also be used to unlock or even automatically open the gate or other barrier to the waste receptacle. The computerized access system 18, according to one aspect of the present invention, includes a computer processor that stores an activated access code when a Consumer purchases permission to dispose of waste material in the waste receptacle or other hazardous waste receptacles. Upon entry of the activated access code by the Consumer, the computerized access system allows the gate or other barrier to the waste receptacle to be temporarily removed to allow the consumer to dispose of the waste material. Similar computerized access systems are currently used in gas station automated car wash systems. According to one aspect of the present invention, a Consumer can be issued a credit voucher or coupons to be used in a commercial establishment 12 for a portion of the consideration value that is paid to the commercial establishment in order to allow disposal of the waste materials 16 in the waste receptacle 10.

The process for the commercialization of waste product disposal according to the principles of the present invention affords two basic benefits. First, it provides the “do-it-yourselfer” and small professional contractor a cost effective and efficient method of waste disposal. Second, it allows the commercial entity to substantially increase consumer traffic at their locations. In order to provide additional consumer traffic, credit vouchers or coupons can be issued to users that can be redeemed at the host establishment for a portion of the amount charged the user for use of the waste disposal system.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A process for the commercialization of waste product disposal, comprising the steps of:
providing a waste receptacle in a commercial location accessible to the general public and remote from any landfill location;
granting permission to a consumer to dispose of waste products in the waste receptacle in exchange for some consideration having monetary or other value; and
transporting waste products from said waste receptacle to a landfill.

2. The process according to claim 1, wherein said step of granting permission to a consumer to dispose of waste products in the waste receptacle includes a cashier station for receipt of said consideration and providing an access receipt for allowing the consumer to have access for disposing of waste products in the waste receptacle.

3. The process according to claim 1, wherein said commercial location is a commercial establishment selected from one of a home products store, a commercial products store, a super center, a discount retailer, a lumber yard, a hardware store, an agricultural store, a warehouse club, or grocery store.

4. The process according to claim 1, further comprising the step of issuing either a credit voucher or coupon to the consumer, to be used in a commercial establishment, for a portion of the consideration value.

5. The process according to claim 1, wherein said step of granting permission to a consumer to dispose of waste products in the waste receptacle includes allowing the consumer to dispose of the waste products and weighing the waste products and charging the consumer on a weight basis for disposal of the waste products.

6. The process according to claim 1, wherein said step of granting permission to a consumer to dispose of waste products in the waste receptacle includes providing the consumer with an access code to enter into an access system to allow the consumer to have access to the waste receptacle.

7. The process according to claim 6, wherein said access system includes a computer processor that stores an activated access code in response to the step of granting permission to a consumer to dispose of waste products in the waste receptacle and upon entry of said activated access code by said consumer, said computer processor allows a barrier to said waste receptacle to be temporarily penetrated.

8. The process according to claim 7, wherein said barrier includes a removable lid on said waste receptacle.

9. The process according to claim 7, wherein said barrier includes a wall-type structure surrounding said waste receptacle and including at least one access door or gate.

10. A process for the commercialization of waste product disposal, comprising the steps of:
providing a waste receptacle at a commercial establishment accessible to the general public;
granting permission to a consumer to dispose of waste products in the waste receptacle in exchange for some consideration having monetary or other value; and
issuing a credit voucher to the consumer, to be used in the commercial establishment, for a portion of the consideration value.
